(19) United States
(12) Patent Application Publication
(10) Pub. No.: US 2018/0121275 A1
(43) Pub. Date: May 3, 2018

(54) METHOD AND APPARATUS FOR DETECTING AND MANAGING FAULTS

(71) Applicant: SAMSUNG SDS CO., LTD., Seoul (KR)

(72) Inventors: Jeong One PARK, Seoul (KR); Wang Geun PARK, Seoul (KR); Sung Hoon CHA, Seoul (KR); Na Un KANG, Seoul (KR); Hyun Min OH, Seoul (KR); Jong Sun KIM, Seoul (KR); Yoon Suk CHO, Seoul (KR); Ji Hoon LEE, Seoul (KR); Ye Seul JANG, Seoul (KR); Young Hun CHUNG, Seoul (KR); Do San PYUN, Seoul (KR)

(73) Assignee: SAMSUNG SDS CO., LTD., Seoul (KR)

(21) Appl. No.: 15/789,075

(22) Filed: Oct. 20, 2017

(30) Foreign Application Priority Data
Oct. 28, 2016 (KR) 10-2016-0141945

(51) Int. Cl. G06F 11/07

(52) U.S. Cl. CPC G06F 11/079; G06F 11/0751; G06F 11/0709

(57) ABSTRACT

A method and apparatus for detecting and managing faults, which can consider both causes from a device where a failure has occurred and causes from other devices as the causes of the failure, is provided. The method and apparatus may provide fault detect managing which divide analysis target data into a normal section and a faulty section and can thus perform fault detection and management using correlation coefficients that can distinctly show a failure.

This application claims priority to Korean Patent Application No. 10-2016-0141945, filed on Oct. 28, 2016, and all the benefits accruing therefrom under 35 U.S.C. § 119, the disclosure of which is incorporated herein by reference in its entirety.

### BACKGROUND

### 1. Field

The present disclosure relates to a method and apparatus for detecting and managing faults, and more particularly, to a method and apparatus for detecting and managing faults, which are capable of detecting whether a target device is faulty by calculating a correlation coefficient for a correlation between two variables and generating a rule set based on the calculated correlation coefficient.

### 2. Description of the Related Art

Infrastructure has been built in various fields such as the fields of information technology (IT), communication networks, and manufacturing. Infrastructure generally has a considerable number of components and has complex connections between the components thereof. Therefore, in a case where a failure occurs in some of the components, the entire infrastructure may not be able to operate normally, and especially, in the case of large-scale infrastructure, the loss and damage incurred by such failure may be very huge.

Thus, the importance of a system for detecting and managing faults for an early detection of a failure has steadily grown. A method of detecting and managing faults based on a single variable is common, but single variable monitoring generally has a high error rate.

FIG. 1 shows the result of detecting a web application server (WAS) hang using a single variable, i.e., CPU usage. Referring to FIG. 1, the CPU usage of a WAS is 0 in both Case 1 (5) and Case 2 (8), but it cannot be concluded that a WAS hang has occurred in both cases because the CPU usage of the WAS may become zero due to a decrease in the number of users. In fact, Case 1 (5) is a false detection of a WAS hang, and only Case 2 (8) corresponds to data where a WAS hang has occurred. FIG. 1 clearly shows an example of false detection of a WAS hang.

In the meantime, a failure in infrastructure arises from various causes, including not only internal causes, i.e., causes from a component where the failure has occurred, but also external causes such as, for example, the organic connections between the components of the infrastructure. However, an existing system for detecting and managing faults performs fault detection and management by taking into consideration only the location of occurrence of a failure and any faults from a device where the failure has occurred, and thus has a limitation in improving the accuracy of fault detection and management.

Therefore, a method of detecting and managing faults is needed which is capable of observing multiple variables at the same time and considering not only internal causes, but also external causes, of a failure occurred in a device in order to lower the false detection rate of single variable-based fault detection and management.

### SUMMARY

Exemplary embodiments of the present disclosure provide a method and apparatus for detecting and managing faults, which can consider both causes from a device where a failure has occurred and causes from other devices as the causes of the failure.

Exemplary embodiments of the present disclosure also provide a method and apparatus for detecting and managing faults, which divide analysis target data into a normal section and a faulty section and can thus perform fault detection and management using correlation coefficients that can distinctly show a failure.

Exemplary embodiments of the present disclosure also provide a method and apparatus for detecting and managing faults, which can detect a failure in advance by generating a rule set based on correlation coefficients with a high degree of deviation.

However, exemplary embodiments of the present disclosure are not restricted to those set forth herein. The above and other exemplary embodiments of the present disclosure will become more apparent to one of ordinary skill in the art to which the present disclosure pertains by referencing the detailed description of the present disclosure given below.

According to the aforementioned and other exemplary embodiments of the present disclosure, the false detection rate of fault detection can be reduced by performing fault detection management based on the correlation coefficient of two variables.

In addition, fault detection and management can be successfully performed even when the causes of a failure lie not only in a device where the failure has occurred, but also in other devices.

Other features and exemplary embodiments may be apparent from the following detailed description, the drawings, and the claims.

### BRIEF DESCRIPTION OF THE DRAWINGS

The above and other exemplary embodiments and features of the present disclosure will become more apparent by describing in detail exemplary embodiments thereof with reference to the attached drawings, in which:

FIG. 1 is a diagram for explaining the problems associated with single variable-based fault detection and management;

FIG. 2 is a block diagram of a system for detecting and managing faults according to an exemplary embodiment of the present disclosure;

FIG. 3 is a block diagram of an apparatus for detecting and managing faults according to an exemplary embodiment of the present disclosure;

FIG. 4 is a flowchart illustrating a method of detecting and managing faults based on correlation coefficients according to an exemplary embodiment of the present disclosure;

FIG. 5 is a diagram for explaining how to extract correlations based on a topology according to some exemplary embodiments of the present disclosure;

FIG. 6 is a flowchart illustrating a method of calculating a correlation coefficient by eliminating a redundant variable from among variables extracted from within the same device according to an exemplary embodiment of the present disclosure;

FIG. 7 is a flowchart illustrating a method of generating a rule set using correlation coefficients according to an exemplary embodiment of the present disclosure;

FIG. 8 is a flowchart illustrating a method of detecting and managing faults for infrastructure using a rule set according to an exemplary embodiment of the present disclosure;

FIG. 9 is a diagram showing failure record data according to some exemplary embodiments of the present disclosure;

FIG. 10 is a diagram showing analysis target data included in failure record data, according to some exemplary embodiments of the present disclosure;

FIG. 11 is a diagram showing reference information according to some exemplary embodiments of the present disclosure;

FIG. 12 is a diagram showing correlations extracted from each layer of infrastructure, according to some exemplary embodiments of the present disclosure;

FIG. 13 is a diagram for explaining how to eliminate a redundant variable from among variables extracted from the same device;

FIG. 14 is a diagram for explaining upper and lower limit thresholds for correlation coefficients extracted from a normal section;

FIG. 15 is a diagram for explaining how to extract correlation coefficients that deviate from the range of upper and lower limit thresholds from a faulty section;

FIG. 16 is a diagram showing a rule set according to some exemplary embodiments of the present disclosure;

FIG. 17 is a diagram for explaining a method of generating a rule set by changing faulty sections according to another exemplary embodiment of the present disclosure; and

FIG. 18 is a hardware configuration diagram of the apparatus according to the exemplary embodiment of FIG. 2.

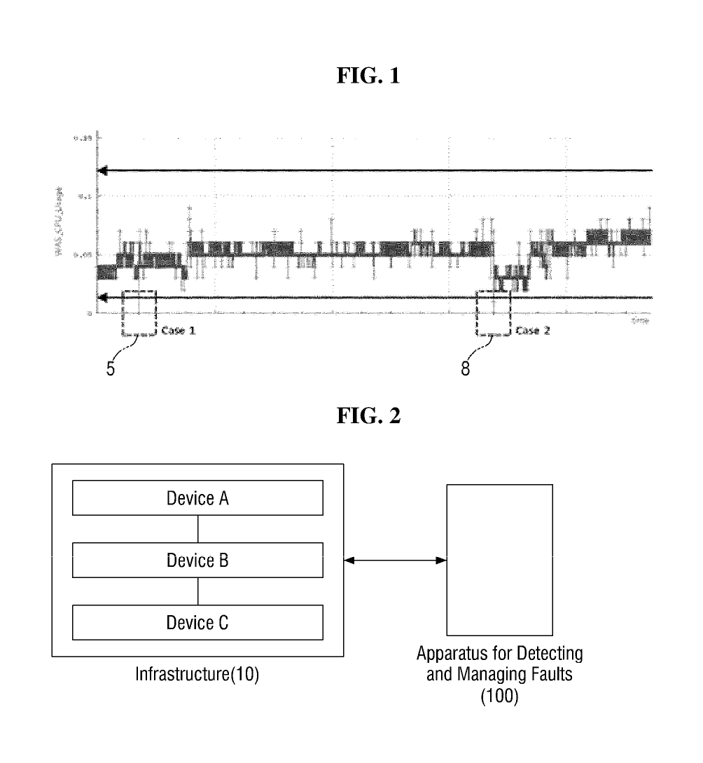

### DETAILED DESCRIPTION

FIG. 2 is a block diagram of a system for detecting and managing faults according to an exemplary embodiment of the present disclosure. Referring to FIG. 2, the system may include infrastructure 10 and an apparatus 100 for detecting and managing faults. The apparatus 100 may be a computing device capable of communicating with the infrastructure 10 in a wired manner and/or a wireless manner.

The infrastructure 10 may have a plurality of components that are different from one another, and the plurality of components may be connected to one another to form a logical/physical topology. The logical topology refers to the arrangement of devices on a computer network and how they communicate with one another. The logical topology describes how signals operate on the computer network.

The apparatus 100 may perform fault detection and management on a plurality of devices that are organically related to one another. As an example, the plurality of components of the infrastructure 10 may be the plurality of devices, but the present disclosure is not limited thereto. That is, any plurality of devices forming a topology may be subjected to fault detection and management.

The infrastructure 10 may include devices A, B, and C. Devices A and B are connected, and devices B and C are connected. That is, devices A, B, and C that constitute the infrastructure 10 form a topology.

The infrastructure 10 may be, for example, a web service system. In this case, the web service system may include web servers, web application servers (WASs), and database (DB) servers, and the web servers, the WASs, and the DB servers may be connected via links and may thus form a topology.

The infrastructure 10 may be, for example, a manufacturing execution system (MES). The MES may be composed of a plurality of processes, and a topology may be formed between the plurality of processes so as to transmit data between the plurality of processes.

Alternatively, the infrastructure 10 may be infrastructure including a plurality of different devices and forming a topology between the plurality of different devices.

The apparatus 100 may predict or detect a failure from the infrastructure 10. The apparatus 100 may receive analysis target data from each of the plurality of devices of the infrastructure 10 and may perform fault detection and management on the infrastructure 10 based on the analysis target data.

The case where the infrastructure 10 and the apparatus 100 are provided separately will hereinafter be described, but alternatively, the apparatus 100 may be incorporated with the infrastructure 10. Thus, each operation performed in connection with exemplary embodiments of the present disclosure will hereinafter be described as being executed by the apparatus 100, but may be understood as being executed by one or more computing devices.

The structure and operation of the apparatus 100 will hereinafter be described with reference to FIG. 3. FIG. 3 is a block diagram of an apparatus for detecting and managing faults according to an exemplary embodiment of the present disclosure.

Referring to FIG. 3, the apparatus 100 includes a correlation coefficient calculation unit 110, a rule set generation unit 120, a fault detection and management unit 130, a storage unit 140, and a communication unit 150.

The correlation coefficient calculation unit 110 may receive analysis target data from the infrastructure 10 via the communication unit 150. The correlation coefficient calculation unit 110 may extract correlations between variables using the analysis target data and may calculate correlation coefficients based on the extracted correlations.

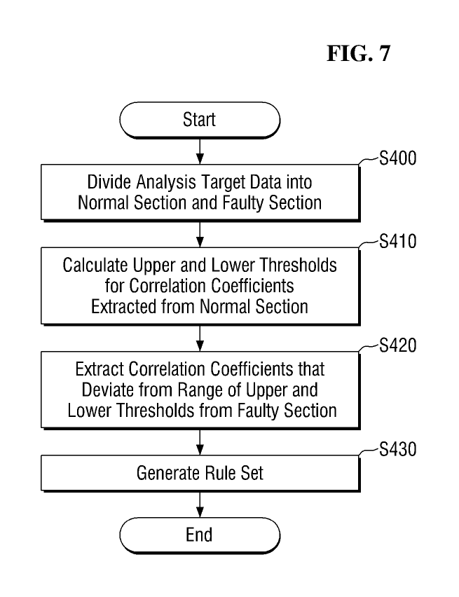

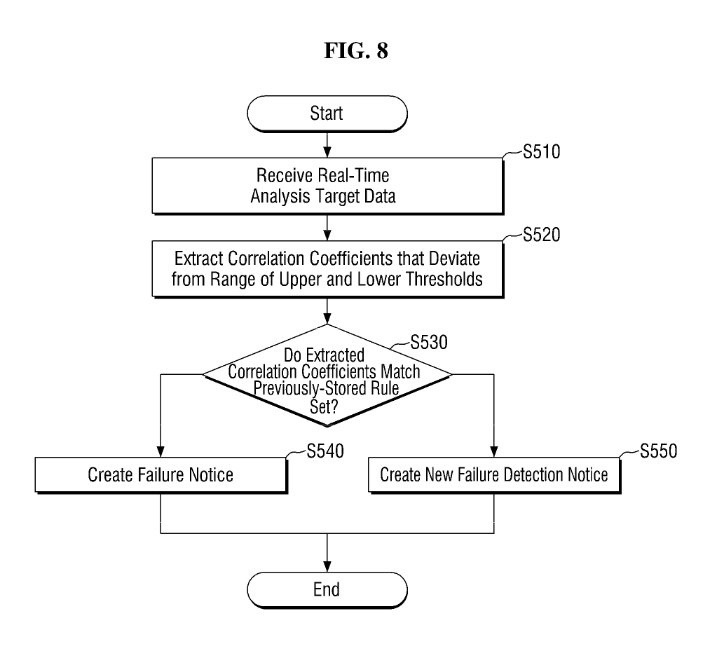

The rule set generation unit 120 may receive the calculated correlation coefficients from the correlation coefficient calculation unit 110, may select some of the calculated correlation coefficients according to a predefined criterion, and may generate a rule set based on the selected correlation coefficients. The generation of a rule set will be described later with reference to FIG. 7. The rule set generation unit 120 may transmit the generated rule set to the storage unit 140 and may thus allow the generated rule set to be stored in the storage unit 140.

If the apparatus 100 receives real-time analysis target data from the infrastructure 10, the correlation coefficient calculation unit 110 may calculate correlation coefficients based on the real-time analysis target data. The fault detection and management unit 130 may receive the correlation coefficients calculated based on the real-time analysis target data from the correlation coefficient calculation unit 110 and may perform fault detection and management based on the received correlation coefficients.

A rule set is generated based on correlations between variables included in analysis target data of each of the plurality of devices of the infrastructure 10 and correlation coefficients for the correlations. When a failure occurs in the infrastructure 10, the correlation coefficients may be varied, and thus, the failure may be monitored based on the varied correlation coefficients.

Specifically, the fault detection and management unit 130 may compare the correlation coefficients calculated based on the real-time analysis target data with a previously-stored rule set and may thus determine whether a failure has occurred in the infrastructure 10. This will be described later with reference to FIG. 8.

The storage unit 140 may store information regarding a rule set, reference information regarding analysis target data, and settings information including information on how to calculate a correlation coefficient and a criterion for choosing a rule set. The correlation coefficient calculation unit 110 may calculate a correlation coefficient by referring to the storage unit 140 as to a criterion for extracting a correlation and how to calculate a correlation coefficient, and the rule set generation unit 120 may generate a rule set by referring to the storage unit 140 as to which correlation coefficients a rule set is to be generated based on.

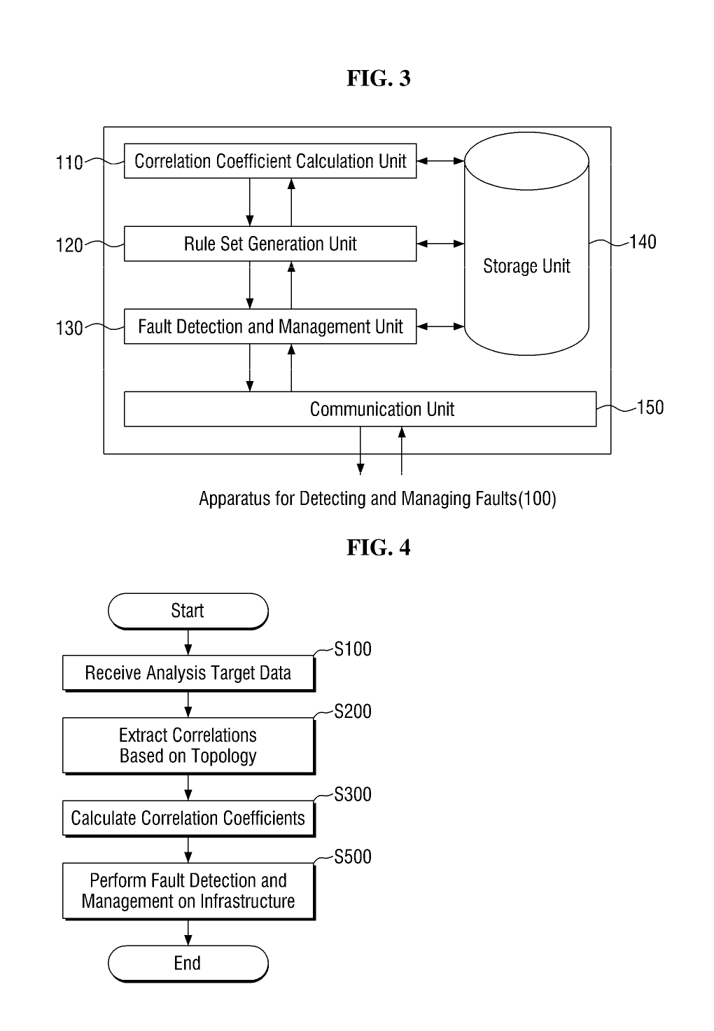

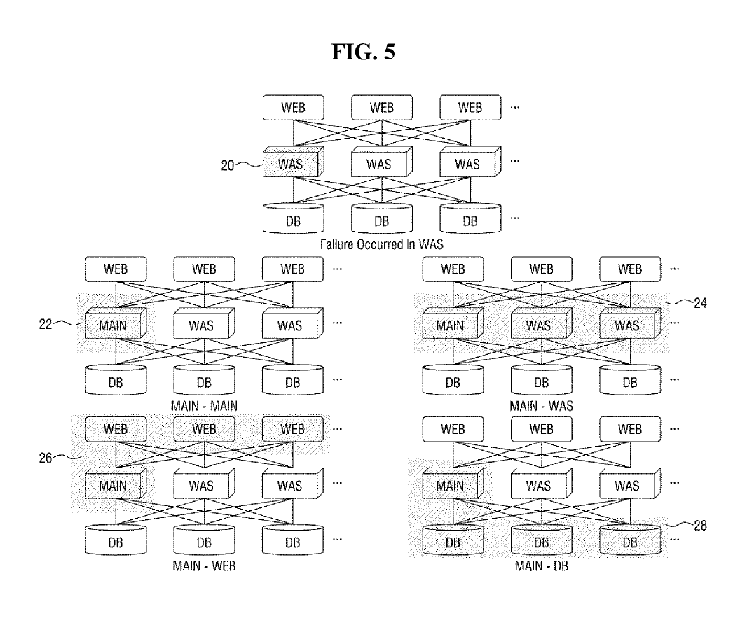

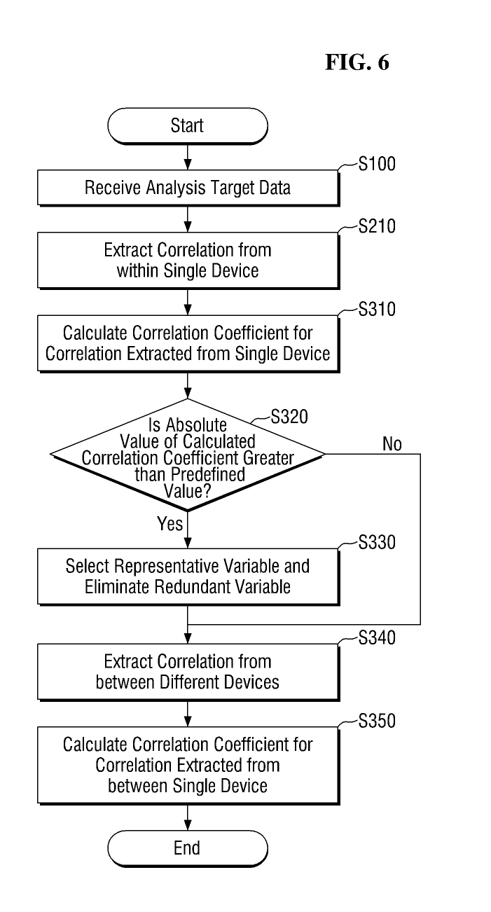

A method of detecting and managing faults according to an exemplary embodiment of the present disclosure will hereinafter be described with reference to FIG. 4. FIG. 4 is a flowchart illustrating a method of detecting and managing faults based on correlation coefficients according to an exemplary embodiment of the present disclosure.

Referring to FIG. 4, the apparatus 100 may receive analysis target data of each of the plurality of devices of the infrastructure 10, which is the target of fault detection and management (S100). The apparatus 100 may extract correlations from the analysis target data based on a topology (S200). Specifically, the apparatus 100 may determine devices from which to extract correlations based on the topology of the infrastructure 10 and may extract correlations from between the determined devices. The apparatus 100 may extract a correlation from within a single device of the infrastructure 10 or from between two different devices of the infrastructure 10. A method of extracting a correlation based on a topology will be described later with reference to FIG. 5.

The apparatus 100 may calculate correlation coefficients based on the extracted correlations (S300) and may perform fault detection and management on the infrastructure 10 based on the calculated correlation coefficients (S500).

The analysis target data received in S100 is data generated by each of the plurality of devices of the infrastructure 10 and may include various information regarding each of the plurality of devices of the infrastructure 10. Accordingly, the causes of a failure occurred in the infrastructure 10 may be identified by analyzing the analysis target data. For example, the analysis target data may be measurements of the amount of variation of a particular variable during a certain period of time, and the particular value may be a variable affecting the occurrence of a failure in the infrastructure 10. The particular variable may be, for example, performance data of parts (such as a central processing unit (CPU), a memory, and the like) of each of the plurality of devices of the infrastructure 10. The analysis target data may be divided into past analysis target data and new analysis target data depending on the time of collection thereof.

The past analysis target data may include information regarding the time of occurrence of a failure occurred in the infrastructure 10 in the past. The past analysis target data is data generated after the occurrence of a failure and may include: 1) the time of occurrence of a failure; and 2) the definition of the failure. Accordingly, the time of occurrence of a failure and the type of the failure can be identified by the past analysis target data, and a rule set, which is reference data for fault detection and management, can be generated using the past analysis target data.

The new analysis target data may be new data that is collected in real time from the infrastructure 10 or is yet to specify a failure. The new analysis target data may be used in fault detection and management or failure analysis through comparison with the past analysis target data.

In S200, Pearson's correlation coefficient calculation method may be used to extract correlations. Pearson's correlation coefficient calculation method is commonly used to determine the correlation between two variables. The Pearson correlation coefficient, r, is a measure of the amount by which x and y vary together or independently of each other and may be defined by the following equation:

$$r = \frac{cov ( X , Y )}{\sqrt{var ( X )} \sqrt{var ( Y )}} = \frac{E ( X - E ( X ) ) E ( Y - E ( Y ) )}{\sqrt{var ( X )} \sqrt{var ( Y )}} = \frac{\sum ( {x}_{i} - \overline{x} ) ( {y}_{i} - \overline{y} )}{\sqrt{\sum {( {x}_{i} - \overline{x} )}^{2}} \sqrt{\sum {( {y}_{i} - \overline{y} )}^{2}}}$$

$$\overline{x} = \frac{1}{n} {\sum }_{i}^{n} {x}_{i} , \overline{y} = \frac{1}{n} {\sum }_{i}^{n} {y}_{i}$$

Pearson's r may have a value of +1 if X and Y are perfectly identical, may have a value of 0 if X and Y are completely different, and may have a value of −1 if X and Y are identical, but in opposite directions.

However, the method used in S200 to extract correlations is not particularly limited to Pearson's correlation coefficient calculation method, and various methods other than Pearson's correlation coefficient calculation method may be used.

Correlations can be extracted based on the topology of the infrastructure 10, and this will hereinafter be described with reference to FIG. 5. FIG. 5 is a diagram for explaining how to extract correlations based on a topology according to some exemplary embodiments of the present disclosure.

For convenience, it is assumed that the infrastructure 10 is a web service system. However, the infrastructure 10 is not limited to being a web service system, and the present disclosure is applicable, almost without any limitation, to any infrastructure that forms a topology between the devices thereof.

A web service system includes web servers, WASs, and DB servers, and each server of the web service system may be a common duplex system. A network topology may exist in the web service system according to a logical/physical flow.

If a failure occurs in a WAS 20 and the starting point of a topology formed in the web service system is limited to the WAS 20, the web service system may be divided into four layers, as shown in FIG. 5.

When the WAS 20 is a main failed server, the web service system may be divided into four layers, i.e., a “main-main” layer 22, a “main-WAS” layer 24, a “main-web” layer 26, and a “main-DB” layer 28. If there are two or more failed servers, the two or more failed servers may all become main servers. The present disclosure may directly apply even when there are multiple main servers.

The apparatus 100 may calculate correlations between variables extracted from each sub-server of each of the layers and correlation coefficients for the correlations based on analysis target data received from each of the plurality of devices of the infrastructure 10.

For example, if 10 variables are extracted from each main server and 20 variables are extracted from each web server, 10*9/2 correlations may be extracted from within the main server of the “main-main” layer 22, and 10*20 correlations may be extracted from between the main server and the web servers of the “main-main” layer 26.

Since correlations are extracted by limiting the topology of the infrastructure 10, correlations that are highly related to a failure occurred in the infrastructure 10 can be selected from among a considerable amount of analysis target data. Since the number of correlations extracted can be reduced, the amount of time that it takes to perform fault detection and management, including the calculation of correlation coefficients, can be reduced.

The number of correlations extracted can also be reduced by eliminating redundant variables among variables extracted from within the same device, and this will hereinafter be described with reference to FIG. 6. FIG. 6 is a flowchart illustrating a method of calculating a correlation coefficient by eliminating redundant variables among variables extracted from within the same device according to an exemplary embodiment of the present disclosure.

Referring to FIG. 6, the apparatus 100 may receive analysis target data (S100), may extract a correlation from within a single device (S210), and may extract a correlation coefficient for the correlation extracted in S210 (S310). S100, S210, and S310 may be performed before the extraction of a correlation between a pair of different devices and the calculation of a correlation coefficient for the extracted correlation in order to eliminate any redundant variable in advance and thus to reduce the number of correlations to be extracted from between the different devices.

The apparatus 100 may determine whether the absolute value of the correlation coefficient extracted in S210 exceeds a predefined value (S320). If the absolute value of the correlation coefficient extracted in S210 exceeds the predefined value, the apparatus 100 may select a representative variable from the correlation coefficients and may eliminate the other redundant variable (S330). Specifically, if a correlation coefficient indicates that two variables are very similar, it may be determined that the two variables can be treated as the same variable, and one of the two variables may be eliminated to improve complexity.

Thereafter, the apparatus 100 extracts a correlation from between a pair of different devices of the infrastructure 10 with any redundant variable eliminated therefrom (S340) and may calculate a correlation coefficient for the correlation extracted in S340 (S350). If the absolute value of the correlation coefficient extracted in S210 does not exceed the predefined value, S330 is not performed, and the method proceeds directly to S340.

In S320, a redundant variable may be detected from between the two variables corresponding to the correlation coefficient extracted in S210 based on the absolute value of the correlation coefficient extracted in S210 because it is assumed that the greater the absolute value of the correlation coefficient extracted in S210, the more similar the two variables corresponding to the correlation coefficient extracted in S210.

For example, if a correlation coefficient is calculated using Pearson's correlation coefficient calculation method, it may be determined that the closer the correlation coefficient is to +1 or −1, the higher the similarity between two variables.

Accordingly, if the absolute value of the correlation coefficient is close to 1 and the two variables are extracted from within the same device, it may be determined that the two variables are very similar and have a very similar meaning. Thus, one of the two variables may be selected as a representative variable, and the other not-selected variable may be eliminated. In this manner, any redundant variable can be eliminated.

In the case of using Pearson's correlation coefficient calculation method, the predefined value may be set to a value close to 1, for example, a value of 0.9 to 0.95. In the case of using a method other than Pearson's correlation coefficient calculation method, the predefined value may be set based on the value of a correlation coefficient for the correlation between two identical variables.

However, a criterion for determining a redundant variable is not particularly limited as long as it can identify two variables with a high similarity therebetween as being redundant, and may vary depending on how to calculate a correlation coefficient. For example, in a case where it is determined that the closer a correlation coefficient is to 0, the higher the similarity between two variables, the predefined value may be set to the absolute value of a value close to 0.

In this manner, the number of correlations to be extracted from between different devices can be reduced by eliminating any redundant variable from among variables extracted from within the same device, and as a result, the complexity of an entire fault detection and management process can be improved.

Referring again to FIG. 5, when there are 10 variables in a main server and 20 variables in a web server, the complexity of correlation coefficient calculation can be reduced from 10*20 to 8*15 by reducing the number of variables of the main server from 10 to 8 and the number of variables of the web server from 20 to 15.

Once correlation coefficients are calculated, the apparatus 100 may generate a rule set using the calculated correlation coefficients. The generation of a rule set will hereinafter be described with reference to FIG. 7. FIG. 7 is a flowchart illustrating a method of generating a rule set using correlation coefficients according to an exemplary embodiment of the present disclosure.

The apparatus 100 generates a rule set in order to create reference data for fault detection and management. Accordingly, a rule set may be generated based on past analysis target data. Since the time of occurrence and the name of a failure occurred in the past are specified in the past analysis target data, the change of data before and after the occurrence of the failure can be identified through analysis. Analysis target data will hereinafter be described as being, for example, time-series data.

Referring to FIG. 7, the apparatus 100 may divide analysis target data into a normal section and a faulty section (S400). Thereafter, the apparatus 100 calculates upper and lower limit thresholds based on correlation coefficients extracted from the normal section (S410), extracts, from the faulty section, correlation coefficients that deviate from the range of the upper and lower limit thresholds (S420), and may generate a rule set using the extracted correlation coefficients (430).

A rule set may include reference information regarding analysis target data and the deviation direction, deviation level, or deviation frequency of the analysis target data. The reference information may include the name of a device that has produced the analysis target data, the names of fault detection and management target items of the device, and the names of performance metrics to be measured from the fault detection and management target items.

As used herein, the term “deviation direction” means the direction in which a correlation coefficient deviates from the upper or lower limit threshold, the term “deviation level” means the amount by which a correlation coefficient deviates from the upper or lower limit threshold, and the term “deviation frequency” means the frequency at which a correlation coefficient deviates from the upper or lower limit threshold.

In S400, the normal section is a section where no failure has occurred and the infrastructure 10 operates normally, and the faulty section is a section where a failure has occurred and is continued. As described above, since the faulty section can be selectively identified from the entire analysis target data, the rest of the analysis target data may be determined as the normal section, thereby dividing the analysis target data into the faulty section and the normal section.

In S410, the upper and lower limit thresholds may be calculated by using a method such as the control limits or an interquartile range (IQR). The upper and lower limit thresholds are calculated in order to specify a normal range of correlation coefficients for a case when the infrastructure 10 operates normally. Correlation coefficients that deviate the most from the upper and lower limit thresholds of the normal range can be found by comparing the normal section and the faulty section.

In S420, correlation coefficients that deviate from the range of the upper and lower limit thresholds are extracted, and a predetermined criterion may be set to select some of the extracted correlation coefficients that deviate the most from the upper or lower limit threshold. For example, correlation coefficients whose deviation levels or frequencies exceed a predefined level may be selected as target correlation coefficients for the generation of a rule set.

Once a rule set is generated based on the past analysis target data, fault detection and management may be performed based on the generated rule set, and this will hereinafter be described with reference to FIG. 8. FIG. 8 is a flowchart illustrating a method of detecting and managing faults for infrastructure using a rule set according to an exemplary embodiment of the present disclosure.

The apparatus 100 may receive real-time analysis target data of each of the plurality of devices of the infrastructure 10, which is the target of fault detection and management (S510). The apparatus 100 may extract correlations based on the real-time analysis target data and may calculate correlation coefficients for the extracted correlations.

The apparatus 100 may extract correlation coefficients that deviate from the range of upper and lower limit thresholds of a normal range, calculated in advance, from among the calculated correlation coefficients (S520). Since the upper and lower limit thresholds are calculated in advance based on past analysis target data, the correlation coefficients that deviate from the range of the upper and lower limit thresholds may be extracted by comparing the calculated correlation coefficients with the upper and lower limit thresholds. It may be determined that in response to correlation coefficients that deviate from the range of the upper and lower limit thresholds being extracted, a failure has occurred or is highly likely to occur.

Once the correlation coefficients that deviate from the range of the upper and lower limit thresholds are extracted, a determination is made as to whether data calculated using the extracted correlation coefficients matches a previously-stored rule set (S530). If the data calculated using the extracted correlation coefficients matches the previously-stored rule set, a failure notice corresponding to the previously-stored rule set may be created (S540). Specifically, various data, such as the deviation levels and deviation frequencies of the correlation coefficients that deviate from the range of the upper and lower limit thresholds, may be calculated and may then be compared with the previously-stored rule set. If the deviation levels and deviation frequencies of the correlation coefficients that deviate from the range of the upper and lower limit thresholds match the previously-stored rule set, it may be determined that the same failure corresponding to the previously-stored rule set has occurred or is highly likely to occur on the infrastructure. Since the previously-stored rule set includes failure type information, a failure notice corresponding to the failure type information may be created.

On the other hand, if the data calculated using the extracted correlation coefficients does not match the previously-stored rule set, a new failure detection notice may be created. Even if the data calculated using the extracted correlation coefficients does not match the previously-stored rule set, it may be determined that a new type of failure has occurred or is highly likely to occur because correlation coefficients that deviate from the normal range have been detected.

In S510, the real-time analysis target data may be data collected from the infrastructure 10, which is the current target of fault detection and management. Any failure may be detected from the infrastructure 10 by extracting correlations and correlation coefficients from the real-time analysis target data and comparing the extracted correlations and correlation coefficients with a previously-generated rule set to determine whether there are any similarities between the extracted correlation coefficients and correlation coefficients corresponding to a failure occurred in the past.

As described above, fault detection and management can be properly performed for an already-known failure by detecting the failure through comparison with a correlation coefficient-based rule set. Also, since a rule set is generated based on correlation coefficients that deviate considerably from a normal range, it can be determined that a failure is highly like to occur if similar correlations are detected. Accordingly, the precision of fault detection and management can be improved.

The aforementioned exemplary embodiments of the present disclosure will hereinafter be described in further detail with reference to FIGS. 9 through 17, assuming that the infrastructure 10 is a web service system. However, the infrastructure 10 is not limited to being a web service system, and the present disclosure is applicable, almost without any limitation, to any infrastructure that forms a topology between the devices thereof.

FIG. 9 is a diagram for explaining failure record data according to some exemplary embodiments of the present disclosure. Referring to FIG. 9, a web service system may store and manage failure record data 200.

The apparatus 100 may receive the failure record data 200 and may generate a rule set for a failure corresponding to the failure record data 200. The generation of a rule set based on the failure record data 200 may correspond to the generation of a rule set based on past analysis target data.

The failure record data 200 is a record of WAS hangs occurred. Serial numbers 1 and 2 indicate WAS hangs occurred in a “WAS1” server, and serial numbers 3 and 4 indicate WAS hangs occurred in a “WAS2” server. By using data corresponding serial numbers 1 through 4, a rule set may be generated in connection with WAS hangs occurred in WASs.

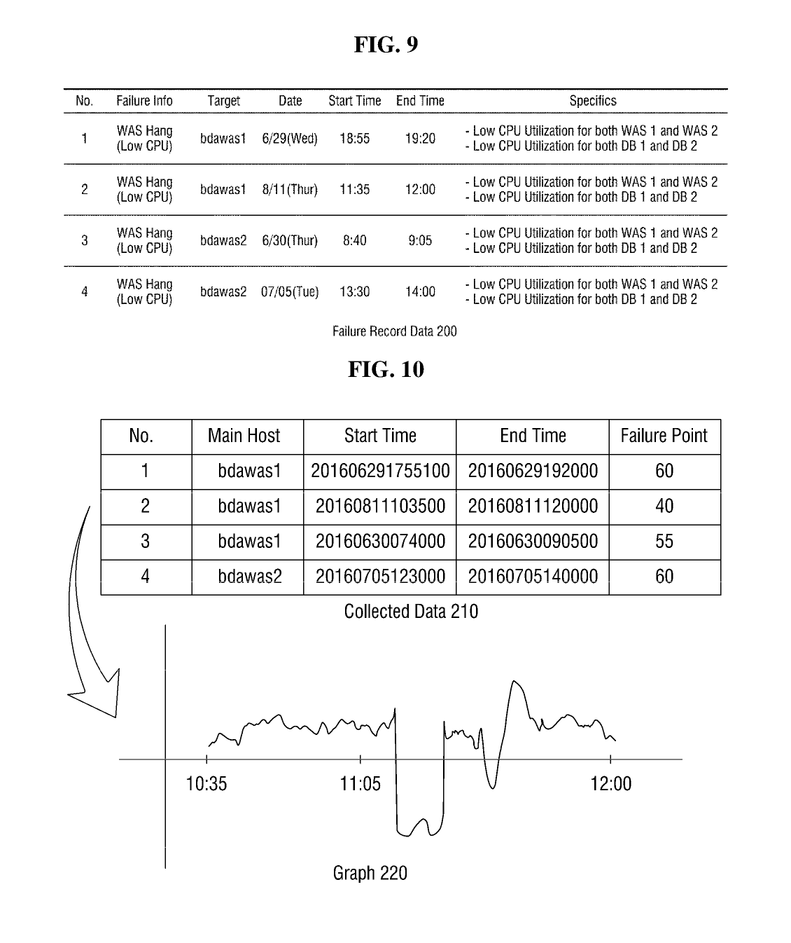

FIG. 10 is a diagram for explaining analysis target data included in the failure record data 200, according to some exemplary embodiments of the present disclosure. Referring to FIG. 10, the failure record data 200 may include collected data 210 collected from a web service system. The collected data 210 may be, for example, time-series data, but the present disclosure is not limited thereto.

The collected data 210 may include “main host” information indicating a device where a failure has occurred, “start time” information indicating the start time of analysis target data, “end time” information indicating the time of the end time of analysis target data, and “failure point” information indicating the starting point of the faulty section of analysis target data with respect to the start time of the analysis target data.

A correlation is extracted using two particular variables of analysis target data corresponding to serial number 2, and a correlation coefficient is calculated for the extracted correlation. The calculated correlation coefficient is represented by a graph 220. Referring to the graph 220, the X axis represents time, and the Y axis represents the value of the calculated correlation coefficient.

The start time of analysis target data corresponding to serial number 2 is “20160811103500”, which means 10:35 on Aug. 11, 2016, and the ending time of the analysis target data corresponding to serial number 2 is “20160811120000”, which means 12:00 on Aug. 11, 2016. For convenience, the graph 200 represents the time in hours.

The faulty section of the analysis target data corresponding to serial number 2 begins at 11:05, which is 40 minutes after the start time of the corresponding analysis target data, i.e., 10:35, and ends at 12:00.

Accordingly, the analysis target data corresponding to serial number 2 may be divided into a normal section ranging from 10:35 to 11:05 and a faulty section ranging from 11:05 to 12:00, upper and lower limit thresholds may be calculated based on correlation coefficients extracted from the normal section, correlation coefficients that are beyond the upper or lower limit threshold may be extracted from the faulty section, and a rule set may be generated based on the extracted correlation coefficients.

Meanwhile, the collected data 210 is assumed to be time-series data having various changes over time. Accordingly, in order to obtain a correlation coefficient on a minute-by-minute basis, a section having a fixed length may be obtained by moving, at a fixed interval, from the beginning of the collected data 210.

For example, a time window may be used. In this example, assuming that the time window is set to an interval of 100 minutes, a section ranging from 06:21 to 08:00 may be obtained, a correlation coefficient may be calculated using the obtained section, and the calculated correlation coefficient may be set as a correlation coefficient at 08:00. Also, a section ranging from 06:22 to 08:01 may be obtained, a correlation coefficient may be calculated using the obtained section, and the calculated correlation coefficient may be set as a correlation coefficient at 08:01.

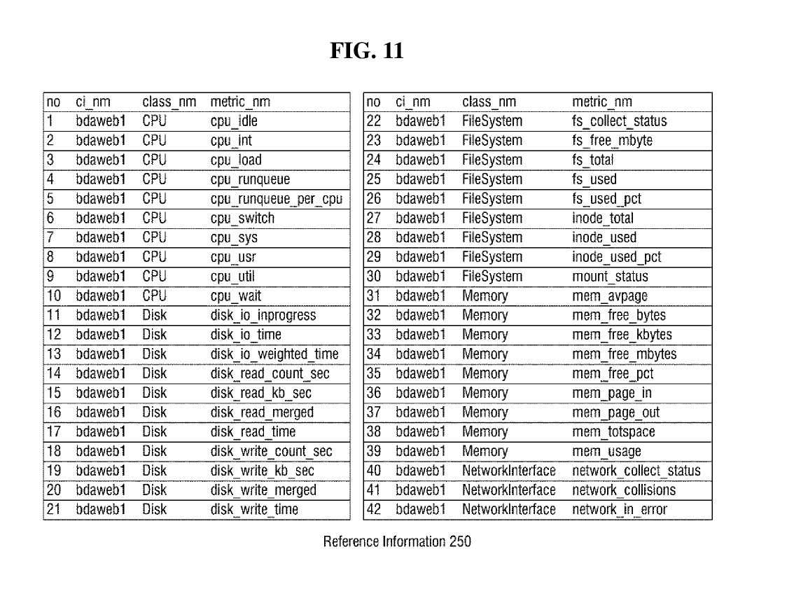

FIG. 11 is a diagram showing reference information according to some exemplary embodiments of the present disclosure. Referring to FIG. 11, reference information 250 may be input to a web service system according to the flow of time.

The reference information 250 may include the name of a server, the names of fault detection and management target items of the server, and the names of performance metrics to be measured from the fault detection and management target items. The reference information 250 may be, for example, reference information regarding a “bdaweb1” server, which is a web server.

Referring to FIG. 11, “ci_name” shows the name of a server, “class_nm” shows the name of a fault detection and management target item of the server, and “metric_nm” shows the name of a performance metric to be measured from the fault detection and management target item. According to the reference information 250, the fault detection and management target items are the CPU, disk, file system, memory, and network interface of the “bdaweb1” server, and performance metrics to be measured from the CPU of the “bdaweb1” server are “cpu_idle” and “cpu_int”. If there is a variation in performance data measured from each fault detection and management target item, the performance data may be used to generate a rule set.

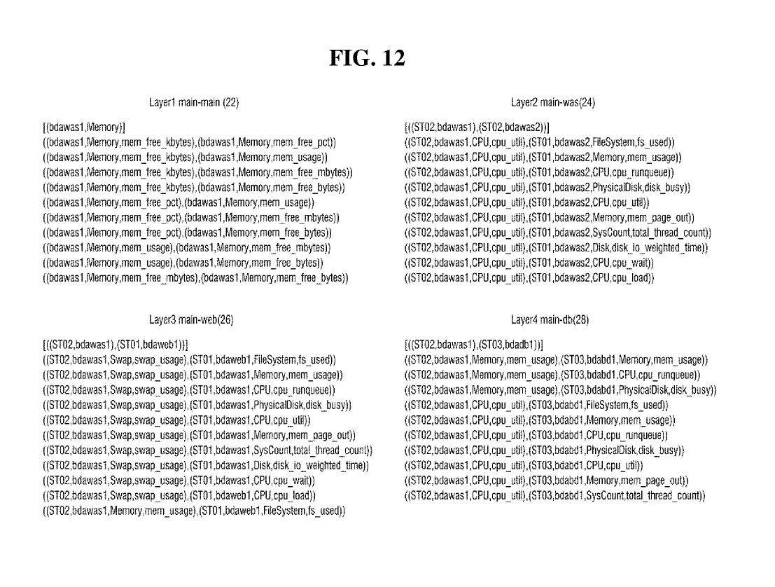

In a web service system, correlations between various performance data may be extracted. In some exemplary embodiments of the present disclosure, correlations may be extracted from each layer defined based on a topology. The extraction of correlations from each of the four layers of FIG. 5 will hereinafter be described with reference to FIG. 12.

FIG. 12 is a diagram showing correlations extracted from each layer, according to some exemplary embodiments of the present disclosure.

Referring to FIG. 12, it is assumed that a failure has occurred in a WAS, i.e., a “bdawas1” server. In the case of Layer 1 (22), correlations may be extracted within the main server, i.e., the “bdawas1” server. FIG. 12 shows only some of the correlations extracted from the “main-main” layer 22, i.e., only correlations between a plurality of memory-related performance data of the “bdawas1” server.

In the case of Layer 2 (24), correlations between the main server and another WAS may be extracted. FIG. 12 shows only some of the correlations extracted from the “main-WAS” layer 24, i.e., only correlations between performance data of the “bdawas1” server and performance data of a “bdawas2” server. Specifically, “((ST02, bdawas1, CPU, cpu_util), (ST01, bdawas2, FileSystem, fs_used))” represents a correlation between “cpu_util” performance of the CPU of the “bdawas1” server and “fs_used” performance of the file system of the “bdawas2” server.

In the case of Layer 3 (26), correlations between the main server and a web server may be extracted. FIG. 12 shows only some of the correlations extracted from the “main-web” layer 26, i.e., only correlations between performance data of the “bdawas1” server and performance data of a “bdaweb1” server. In the case of Layer 4 (28), correlations between the main server and a DB server may be extracted. FIG. 12 shows only some of the correlations extracted from the “main-DB” layer 28, i.e., only correlations between performance data of the “bdawas1” server and performance data of a “bdadb1” server.

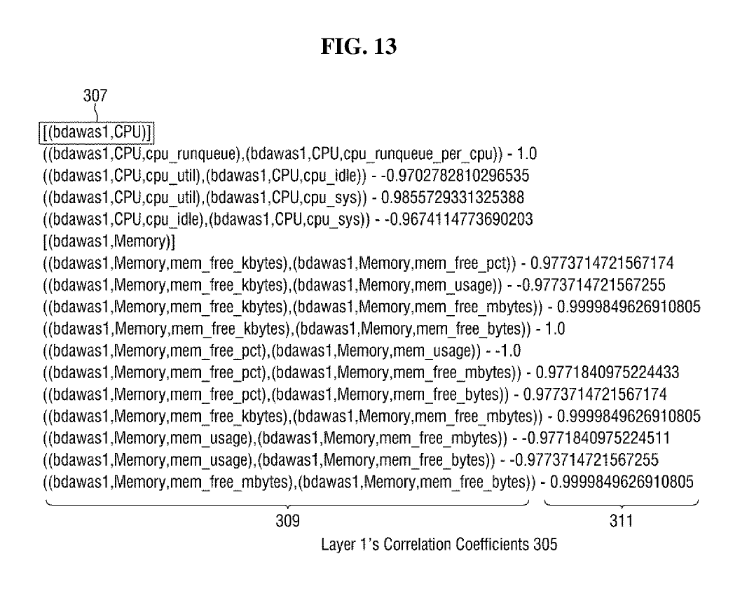

Once correlations are extracted, correlation coefficients are calculated for the extracted correlations. Correlation coefficients for the correlations extracted from each of Layer 1 (22), Layer 2 (24), Layer 3 (26), and Layer 4 (28) may be calculated in parallel. Alternatively, as described above with reference to FIG. 6, correlation coefficients may be calculated first for the correlations extracted from Layer 1 (22), thereby reducing the total number of correlations that need to be processed, and this will hereinafter be described with reference to FIG. 13.

FIG. 13 is a diagram for explaining how to eliminate a redundant variable from among variables extracted from the same device.

Specifically, FIG. 13 shows correlation coefficient data 305 for correlations extracted from Layer 1 (22). Referring to FIG. 13, reference numeral 307 shows the name of a server and the name of a fault detection and management target item of the server, reference numeral 309 represents correlations extracted from Layer 1 (22), and reference numeral 311 represents correlation coefficients for the correlations 309.

The correlation coefficients 311 are correlation coefficients obtained by Pearson's correlation coefficient calculation method. As described above, it may be determined that the closer a correlation coefficient is to +1 or −1, the higher the similarity between two variables. Also, since a pair of variables having a similarity exceeding a predefined value therebetween are considered as being redundant, one of the pair of variables may be selected as a representative variable, and the other redundant variable may be eliminated.

FIG. 13 shows only correlation coefficients 309 that are equal to, or greater than, a predefined value of 0.95 among other correlation coefficients extracted from Layer 1 (22). The predefined value of 0.95 may be varied. Since a correlation “((bdawas1, CPU, cpu_runqueue), (bdawas1, CPU, cpu_runqueue_per_cpu))” has a correlation coefficient of 1.0, the two variables in the correlation “((bdawas1, CPU, cpu_runqueue), (bdawas1, CPU, cpu_runqueue_per_cpu))”, i.e., “cpu_runqueue” and “cpu_runqueue_per_cpu”, may be determined as being positively correlated and being identical. Thus, one of “cpu_runqueue” and “cpu_runqueue_per_cpu” may be selected as a representative variable, and the other not-selected variable may be eliminated. If “cpu_runqueue” is selected as the representative variable, “cpu_runqueue_per_cpu” may be eliminated, and only correlations between “cpu_runqueue” and other variables may be considered when extracting correlations from other layers. In this manner, the number of correlations that need to be taken into consideration can be reduced, and as a result, the speed of fault detection and management can be improved.

Once correlation coefficients are calculated for Layer 1 (22), correlation coefficients are calculated for the other layers, i.e., Layer 2 (24), Layer 3 (26), and Layer 4 (28). Once the calculation of correlation coefficients is complete, analysis target data is divided into a normal section and a faulty section. As described above, correlation coefficients that can distinctly show a failure can be extracted by comparing correlation coefficients extracted from the normal section and correlation coefficients extracted from the faulty section.

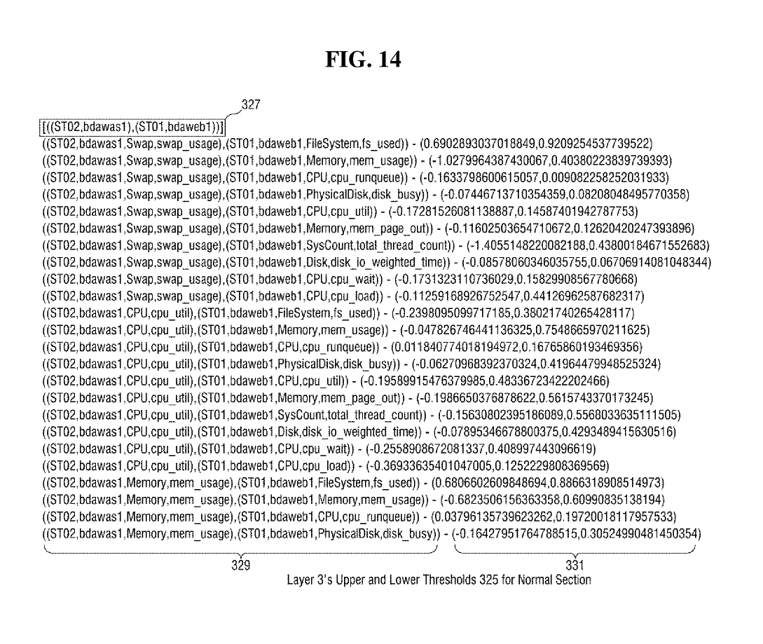

The apparatus 100 may divide analysis target data into a normal section and a faulty section and may calculate upper and lower limit thresholds for correlation coefficients extracted from the normal section, and this will hereinafter be described with reference to FIG. 14. FIG. 14 is a diagram for explaining upper and lower limit thresholds for correlation coefficients extracted from a normal section.

Specifically, FIG. 14 shows upper/lower limit threshold data 325 for correlations extracted from Layer 3 (26). Referring to FIG. 14, reference numeral 327 shows the type and name of a server, reference numeral 329 represents correlations, and reference numeral 331 represents upper and lower limit thresholds.

A web server is marked as “ST01”, a WAS is marked as “ST02”, and a DB server is marked as “ST03”. Referring to “((ST02, bdawas1, Swap, swap_usage), (ST01, bdaweb1, FileSystem, fs_used))-(0.6902893037018849, 0.9209254537739522)”, there is a correlation between “swap_usage” of a “bdawas1” server, which is a WAS, and “fs_used” of a “bdeweb1”, which is a web server, and lower and upper limit thresholds for a corresponding correlation coefficient in a normal range of deviation are 0.6902893037018849 and 0.9209254537739522, respectively.

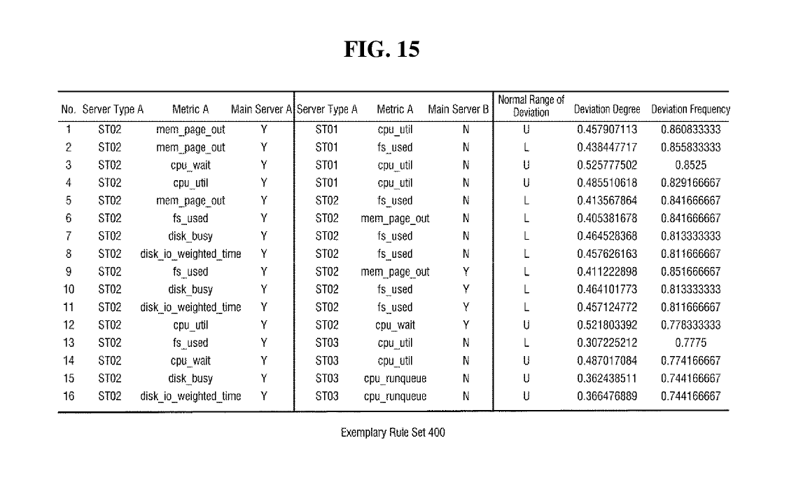

Once the upper and lower limit thresholds are calculated, correlation coefficients that are beyond the upper or lower limit threshold may be extracted from a faulty section, and this will hereinafter be described with reference to FIG. 15. FIG. 15 is a diagram for explaining how to extract correlation coefficients that deviate from the range of upper and lower limit thresholds from a faulty section.

Example 1 (410) and Example 2 (420) of FIG. 15 are graphs showing the variation of correlation coefficients for different correlations during a faulty section. The length of the entire faulty section may be 60 minutes. Referring to FIG. 15, reference characters U and L represent upper and lower limit thresholds, respectively, calculated for a normal section.

Since the correlation coefficient of Example 1 (410) exceeds the upper limit threshold U for 30 minutes in an area a between a point 1 and a point 2, the area a becomes a limit threshold deviation section. Since the length of the limit threshold deviation section accounts for half the length of the entire faulty section, the deviation frequency of the correlation coefficient of Example 1 (410) may be calculated as 0.5 (=30/60). The deviation level of the correlation coefficient of Example 1 (410) is proportional to the amount by which the correlation coefficient of Example 1 (410) is beyond the upper limit threshold U. For example, the average difference between the value of the correlation coefficient of Example 1 (410), measured minutely during the period of the limit threshold deviation section, and the upper limit threshold U may be used as the deviation level of the correlation coefficient of Example 1 (410). That is, the average of the differences between the upper limit threshold U and values of the correlation coefficient of Example 1 (410) measured for 30 minutes may be used as the deviation level of the correlation coefficient of Example 1 (410). The deviation direction of the correlation coefficient of Example 1 (410) may be the direction of the upper limit threshold U because the value of the correlation coefficient of Example 1 (410) is beyond the upper limit threshold U during the period of the limit threshold deviation section.

The correlation coefficient of Example 2 (420) exceeds the upper or lower limit threshold U or L in an area b between a point 1 and a point 2, an area c between a point 4 and a point 5, and an area d between a point 6 and a point 7. In the area b, the correlation coefficient of Example 2 (420) is above the upper limit threshold U, and in the areas c and d, the correlation coefficient of Example 2 (420) is below the lower limit threshold L. Since the deviation direction of the correlation coefficient of Example 2 (420) in the area a differs from the deviation direction of the correlation coefficient of Example 2 (420) in the areas c and d, the direction in which the correlation coefficient of Example 2 (420) is beyond the corresponding limit threshold more often, i.e., the direction of the lower limit threshold L, may be selected as the deviation direction of the correlation coefficient of Example 2 (420).

In each of the areas c and d, the correlation coefficient of Example 2 (420) is beyond the lower limit threshold L for ten minutes, and thus, the deviation frequency of the correlation coefficient of Example 2 (420) in each of the areas c and d may be 0.33 (=20/60). The deviation direction of the correlation coefficient of Example 2 (420) may be calculated in the aforementioned manner. Since deviation direction, deviation level, and deviation frequency can be calculated for multiple correlations, the apparatus 100 may select correlation coefficients with a high degree of deviation. Once correlation coefficients with a high degree of deviation are selected, a rule set may be generated based on the selected correlation coefficients.

Since each correlation coefficient reflects the variation of both variables thereof and the apparatus 100 generates a rule set based on correlation coefficients with a high degree of deviation, the probability of early detection of a failure can be improved, and the false detection of a failure can be reduced.

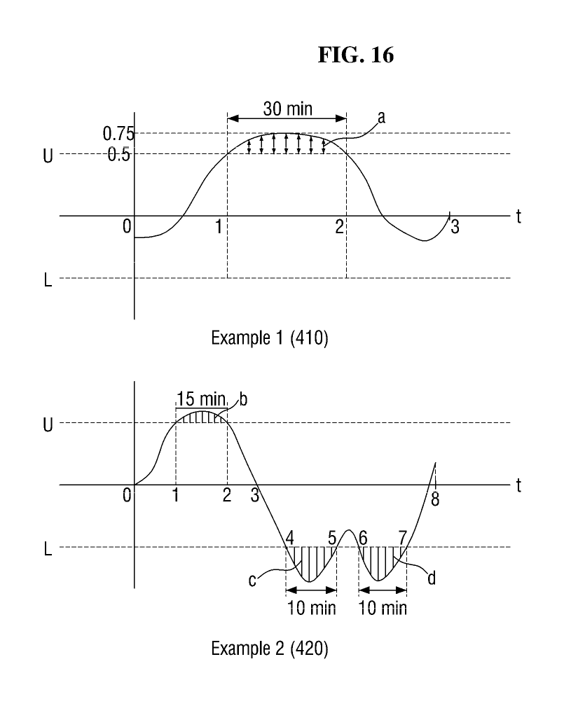

FIG. 16 is a diagram showing a rule set according to some exemplary embodiments of the present disclosure. Referring to FIG. 16, an exemplary rule set 400 may include server type information, metric information, information indicating whether each server is a main server, deviation direction information, deviation level information, and deviation frequency information.

The exemplary rule set 400 is a rule set generated when a web service system is divided into a total of four layers, i.e., the “main-main” layer, the “main-WAS” layer, the “main-web” layer, and the “main-DB” layer of FIG. 5, and is composed of four correlation coefficients with a high degree of deviation, extracted from each of the four layers.

Serial numbers 1 through 4 correspond to the correlation coefficients extracted from the “main-web” layer, serial numbers 5 through 8 correspond to the correlation coefficients extracted from the “main-WAS” layer, serial numbers 9 through 12 correspond to the correlation coefficients extracted from the “main-main” layer, and serial numbers 13 through 16 correspond to the correlation coefficients extracted from the “main-DB” layer.

Since correlations are extracted by mixing variables from different devices, not only the problems associated with a failed server, but also the problems associated with other servers, can be considered when detecting a failure. That is, even when the causes of failure lie in a device other than a device where the failure has occurred, the failure can be detected in advance using a correlation coefficient-based rule set, and thus, the precision of fault detection and management can be improved.

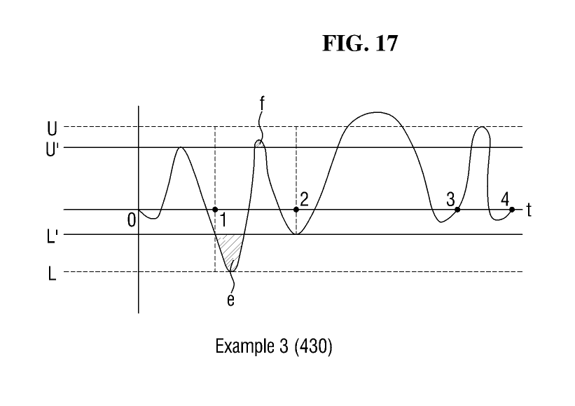

Meanwhile, a rule set may be generated not only for a faulty section, but also for a particular section before the occurrence of a failure, through the analysis of past analysis target data that specifies the faulty section, the precision of fault detection and management can be further improved. Also, any critical failure that may occur in the infrastructure 10 can be thoroughly monitored. This will hereinafter be described with reference to FIG. 17.

FIG. 17 is a diagram for explaining a method of generating a rule set by changing faulty point according to another exemplary embodiment of the present disclosure. Referring to FIG. 17, Example 3 (430) is a graph showing a normal section and the faulty section of Example 1 (410) of FIG. 15.

A section between a point 2 and a point 3 is the faulty section of Example 1 (410), and an entire section between a point 0 to a point 4 except for the section between the point 2 and the point 3 is a normal section. The section between the point 2 and the point 3 will hereinafter be referred to as a first faulty section, and the entire section between the point 0 and the point 4 except for the section between the point 2 and the point 3 will hereinafter be referred to as a first normal section. Reference characters U and L represent upper and lower limit thresholds, respectively, for the first normal section.

In order to generate a rule set for a particular section before the occurrence of a failure, part of the first faulty section may be set as a second faulty section, which differs from the first faulty section.

Specifically, the starting point of the first faulty section, i.e., the point 2, is set as the end point of the second faulty section, and a point a predetermined amount of time ahead of the point 2 may be set as the starting point of the second faulty section. The amount of time of the second faulty section may be set in advance or may be set later in consideration of the criticality of a failure occurred. A point a predetermined amount of time ahead of the starting point of the first faulty section may be set as the starting point of the second faulty section.

In Example 3 (430), it is assumed that a point 1 is set as the starting point of the second faulty section. In this case, a section between a point 1 and a point 2 may be set as the second faulty section. The entire section between a point 0 and a point 4 except for the first and second faulty sections, i.e., the section between the point 0 and the point 1 and the section between a point 3 and a point 4, may be set as a second normal section corresponding to the second faulty section.

The generation of a rule set may be performed using the second normal section and the second faulty section. Specifically, upper and lower limit thresholds for correlation coefficients for the second normal section are calculated, and a rule set may be generated by extracting correlation coefficients that deviate from the range of the calculated upper and lower limit thresholds from the second faulty section.

Since the upper and lower limit thresholds for the second normal section are U′ and L′, respectively, areas e and f may become limit threshold deviation sections for the second faulty section. Then, a rule set may be generated by calculating deviation direction, deviation level, and deviation frequency using the limit threshold deviation sections e and f.

Since in Example 3 (430), a rule set is generated for each of the first and second faulty sections, two rule sets can be used to detect a particular failure. In this case, the probability of detection of a failure can be further improved using the rule set generated for the second faulty section.

In response to real-time analysis target data that matches a newly generated rule set being received, the apparatus 100 may create an early warning notice for a failure corresponding to a first faulty section.

Also, by using changes in a rule set, a pattern may be extracted. The pattern may be, for example, a pattern regarding the rate of increase of the deviation level or frequency of a correlation coefficient, such as the pattern in which the deviation level or frequency of a correlation coefficient increases linearly or exponentially, or the pattern of change of a specific numerical value.

Once the pattern is extracted from the real-time analysis target data, the apparatus 100 may perform fault detection and management by comparing a previously-stored pattern with the pattern extracted from the real-time analysis target data. Accordingly, the apparatus 100 can cover a wide range of faulty sections through the comparison of patterns for multiple faulty sections, and can enhance the detection rate of a failure, especially when the failure occurs slowly.

Each of the methods according to the aforementioned exemplary embodiments of the present invention may be performed by executing a computer program realized as computer-readable code. The computer program may be transmitted from a first computing device to a second computing device via a network, such as the Internet, and may then be installed and used in the second computing device. Examples of the first and second computing devices include server devices, physical servers belonging to a server pool for cloud services, and fixed computing devices such as desktop personal computers (PCs).

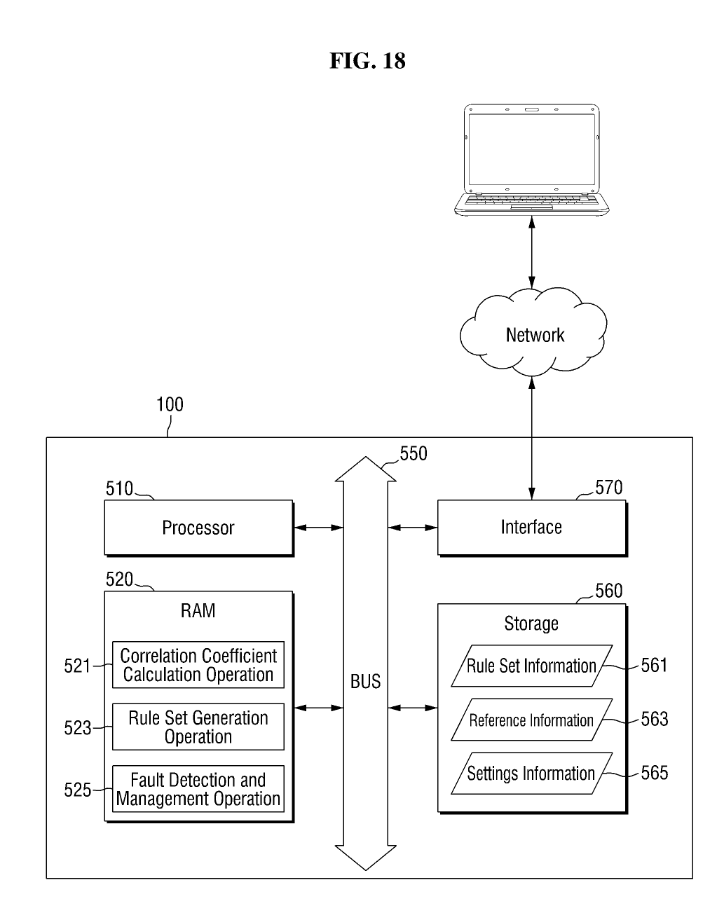

FIG. 18 is a hardware configuration diagram of the apparatus according to the exemplary embodiment of FIG. 2.

Referring to FIG. 18, the apparatus 100 may include at least one processor 510, a memory 520, a storage 560, and an interface 570. The processor 510, the memory 520, the storage 560, and the interface 570 exchange data with one another via a system bus 550.

The processor 510 executes a computer program loaded in the memory 520, and the memory 520 loads the computer program therein from the storage 560. The computer program may include a correlation coefficient calculation operation 521, a rule set generation operation 523, and a fault detection and management operation 535.

The correlation coefficient calculation operation 521 may receive analysis target data from the infrastructure 10, which is the target of fault detection and management, via the network interface 570. The correlation coefficient calculation operation 521 may extract correlations based on a topology by referencing the received analysis target data and reference information 563 present in the storage 560. The correlation coefficient calculation operation 521 may calculate correlation coefficients for the extracted correlations by referencing settings information 565 present in the storage 560.

The rule set generation operation 523 receives the calculated correlation coefficients via the correlation coefficient calculation operation 521, selects correlation coefficients that meet a predefined criterion from among the received correlation coefficients, and generates a rule set based on the selected correlation coefficients. The generated rule set is stored in the storage 560 as rule set information 561.

The fault detection and management operation 525 receives real-time analysis target data processed by the correlation coefficient calculation operation 521, compares the received real-time analysis target data with the rule set information 561, and performs fault detection and management on the infrastructure 10 based on the result of the comparison.

The storage 560 may include the rule set information 561, the reference information 563, and the settings information 565.

The rule set information 561 may include a rule set generated based on past analysis target data. The rule set generated based on the past analysis target data may be used as reference data for fault detection and management. The reference information 563 may be information regarding analysis target data, and the settings information 565 may include various settings regarding, for example, how to calculate a correlation coefficient and how to select a rule set.

What is claimed is:

1. A method of detecting and managing faults in a plurality of devices, comprising:
receiving analysis target data generated by each of the plurality of devices;
selecting a first device and a second device from which to extract correlation coefficients, the first device and the second device being selected from among the plurality of devices, and the first device and the second device being different from each other;
extracting first correlation coefficients between variables included in analysis target data of the first device and variables included in analysis target data of the second device; and
determining whether the plurality of devices are faulty based on the first correlation coefficients.

2. The method of claim 1, further comprising:
calculating second correlation coefficients between variables included in analysis target data of one of the plurality of devices; and
selecting a first one among a pair of variables of each of the second correlation coefficients as a representative variable and eliminating a second one among the pair of variables of each of the second correlation coefficients as a redundant variable if the second correlation coefficients meet a predefined criterion.

3. The method of claim 1, wherein the selecting the first device and the second device, comprises:
defining a layer including a device where a failure has occurred using a topology of the plurality of devices; and
determining devices that constitute the defined layer as the first device and the second device.

4. The method of claim 1, further comprising:
dividing the analysis target data into a first normal section and a first faulty section;
calculating a first upper limit threshold and a first lower limit threshold based on the first correlation coefficients obtained from the first normal section;
extracting third correlation coefficients outside a range between the first upper limit threshold and the first lower limit threshold from among the first correlation coefficients obtained from the first normal section; and
generating a first rule set using the extracted third correlation coefficients.

5. The method of claim 4, wherein the generating the first rule set comprises selecting third correlation coefficients that meet a predefined criterion from among the third correlation coefficients that deviate from the range between the first upper limit threshold and the first lower limit threshold and generating the first rule set using the selected third correlation coefficients, and
wherein the predefined criterion is a higher value of deviation from the range between the first upper limit threshold and the first lower limit threshold than a predefined value.

6. The method of claim 4, wherein the generating the first rule set comprises generating the first rule set using partial correlation coefficient selected from the third correlation coefficient by a predefined criterion,
wherein the predefined criterion is a higher value of a frequency of deviation than a predetermined value.

7. The method of claim 4, wherein the determining whether the plurality of devices are faulty comprises:
receiving real-time analysis target data generated by each of the plurality of devices;
calculating fourth correlation coefficients corresponding to the first correlation coefficients based on the real-time analysis target data;
extracting fourth correlation coefficients that deviate from the range of the first upper limit threshold and the first lower limit threshold from among the calculated fourth correlation coefficients; and
creating a failure notice corresponding to the first rule set if the extracted fourth correlation coefficients match the first rule set and creating a new failure detection notice if the extracted fourth correlation coefficients do not match the first rule set.

8. The method of claim 4, further comprising:
setting a point in the first normal section, the point being a predetermined amount of time ahead of a starting point of the first faulty section, as a starting point of a second faulty section and setting the starting point of the first faulty section as an end point of the second faulty section;
setting all of the first normal section except for the first faulty section and the second faulty section as a second normal section;
calculating a second upper limit threshold and a second lower limit threshold based on the first correlation coefficients obtained from the second normal section;
extracting fifth correlation coefficients that deviate from the range between the second upper limit threshold and the second lower limit threshold from among the first correlation coefficients obtained from the second faulty section; and
generating a second rule set using the extracted fifth correlation coefficients.

9. The method of claim 8, further comprising creating a pattern using the first rule set and the second rule set.

10. The method of claim 8, wherein the determining whether the plurality of devices are faulty comprises:
extracting fourth correlation coefficients that deviate from the range between the second upper limit threshold and the second lower limit threshold from among the calculated fourth correlation coefficients; and
creating an early warning notice for a failure corresponding to the first rule set if the extracted fourth correlation coefficients match the first rule set.

11. A non-transitory computer readable recording medium having embodied thereon a program, which when executed by a processor, causes the processor to execute a method including:
receiving analysis target data generated by each of the plurality of devices;
selecting a first device and a second device from which to extract correlation coefficients, the first device and the second device being selected from among the plurality of devices, and the first device and the second device being different from each other;
extracting first correlation coefficients between variables included in analysis target data of the first device and variables included in analysis target data of the second device; and
determining whether the plurality of devices are faulty based on the first correlation coefficients.

12. The non-transitory computer readable recording medium of claim 11, wherein the program, when executed by the processor, further causes the processor to execute:
calculating second correlation coefficients between variables included in analysis target data of one of the plurality of devices; and
selecting a first one among a pair of variables of each of the second correlation coefficients as a representative variable and eliminating a second one among the pair of variables of each of the second correlation coefficients as a redundant variable if the second correlation coefficients meet a predefined criterion.

13. The non-transitory computer readable recording medium of claim 11, wherein the selecting the first device and the second device, comprises:
defining a layer including a device where a failure has occurred using a topology of the plurality of devices; and
determining devices that constitute the defined layer as the first device and the second device.

14. The non-transitory computer readable recording medium of claim 11, wherein the program, when executed by the processor, further causes the processor to execute:
dividing the analysis target data into a first normal section and a first faulty section;
calculating a first upper limit threshold and a first lower limit threshold based on the first correlation coefficients obtained from the first normal section;
extracting third correlation coefficients outside a range between the first upper limit threshold and the first lower limit threshold from among the first correlation coefficients obtained from the first normal section; and
generating a first rule set using the extracted third correlation coefficients.

15. The non-transitory computer readable recording medium of claim 14, wherein the generating the first rule set comprises selecting third correlation coefficients that meet a predefined criterion from among the third correlation coefficients that deviate from the range between the first upper limit threshold and the first lower limit threshold and generating the first rule set using the selected third correlation coefficients, and
wherein the predefined criterion is a higher value of deviation from the range between the first upper limit threshold and the first lower limit threshold than a predefined value.

16. The non-transitory computer readable recording medium of claim 14, wherein the determining whether the plurality of devices are faulty comprises:
receiving real-time analysis target data generated by each of the plurality of devices;
calculating fourth correlation coefficients corresponding to the first correlation coefficients based on the real-time analysis target data;
extracting fourth correlation coefficients that deviate from the range of the first upper limit threshold and the first lower limit threshold from among the calculated fourth correlation coefficients; and
creating a failure notice corresponding to the first rule set if the extracted fourth correlation coefficients match the first rule set and creating a new failure detection notice if the extracted fourth correlation coefficients do not match the first rule set.

17. The non-transitory computer readable recording medium of claim 14, wherein the program, when executed by the processor, further causes the processor to execute:
setting a point in the first normal section, the point being a predetermined amount of time ahead of a starting point of the first faulty section, as a starting point of a second faulty section and setting the starting point of the first faulty section as an end point of the second faulty section;
setting all of the first normal section except for the first faulty section and the second faulty section as a second normal section;
calculating a second upper limit threshold and a second lower limit threshold based on the first correlation coefficients obtained from the second normal section;
extracting fifth correlation coefficients that deviate from the range between the second upper limit threshold and the second lower limit threshold from among the first correlation coefficients obtained from the second faulty section; and
generating a second rule set using the extracted fifth correlation coefficients.

18. The non-transitory computer readable recording medium of claim 17, wherein the program, when executed by the processor, further causes the processor to execute creating a pattern using the first rule set and the second rule set.

19. The non-transitory computer readable recording medium of claim 17, wherein the determining whether the plurality of devices are faulty comprises:
extracting fourth correlation coefficients that deviate from the range between the second upper limit threshold and the second lower limit threshold from among the calculated fourth correlation coefficients; and
creating an early warning notice for a failure corresponding to the first rule set if the extracted fourth correlation coefficients match the first rule set.
